(19) United States
(12) Patent Application Publication
(10) Pub. No.: US 2026/0312686 A1
(43) Pub. Date: Oct. 8, 2026

(54) MICROWAVE PHOTON BROADBAND PHASE-STABILIZED TRANSMISSION CENTER STATION BASED ON AMPLITUDE-PHASE MULTIPLEXING AND TRANSMISSION SYSTEM HAVING THE SAME

(71) Applicant: CHINA ELECTRONICS TECHNOLOGY GROUP CORPORATION NO 44 RESEARCH INSTITUTE, CHONGQING (CN)

(72) Inventors: HAO ZHANG, CHONGQING (CN); PENGFEI QU, CHONGQING (CN)

(21) Appl. No.: 19/266,200

(22) Filed: Jul. 11, 2025

(30) Foreign Application Priority Data
Apr. 7, 2025 (CN) 202510430199.X

(51) Int. Cl. H04B 10/25; H04B 10/516; H04L 7/00

(52) U.S. Cl. CPC H04B 10/2589; H04B 10/5161; H04L 7/0075

(57) ABSTRACT

A microwave photon broadband phase-stabilized transmission center station based on amplitude-phase multiplexing and transmission system having the same are provided. The microwave photon broadband phase-stabilized transmission center station includes a sensing reference signal source configured to output a sensing reference signal, a modulation unit, and a delay adjustment unit. The modulation unit is configured to convert a broadband microwave signal to be transmitted to an optical domain to form a central station optical carrier broadband microwave signal, and load the sensing reference signal onto the central station optical carrier broadband microwave signal to form a composite optical carrier broadband microwave signal. The delay adjustment unit is configured to output the composite optical carrier broadband microwave signal to an optical fiber link after delaying, receive the loopback composite optical carrier broadband microwave signal, and compensate for a true delay fluctuation of the optical fiber link.

### TECHNICAL FIELD

The present disclosure relates to a field of microwave photons, and in particular to a microwave photon broadband phase-stabilized transmission center station based on amplitude-phase multiplexing and transmission system having the same.

### BACKGROUND

At present, high-precision optical fiber microwave frequency transmission faces a problem that a transmission delay of an optical fiber link changes with factors such as temperature, stress, vibration, and transmission wavelength, causing a frequency/phase of a transmitted microwave frequency signal to jitter and drift. In a distributed microwave frequency transmission system, it is impossible to ensure that each user node is able to achieve phase synchronization/consistent frequency signal reception.

Currently, in microwave photon broadband frequency transmission, an active compensation mechanism based on a loopback method is commonly introduced to realize high-precision and consistent transmission. However, delay information or phase fluctuation information of the optical fiber link is unable to be directly extracted from a broadband microwave frequency signal, and a reference signal needs to be introduced to sense the optical fiber link. Moreover, in order to prevent the reference signal from interfering with the broadband microwave signal received at a remote user terminal, the optical fiber link generally adopts a wavelength division multiplexing architecture for bidirectional transmission. However, a transmitted broadband microwave frequency signal and the reference signal are optically modulated and demodulated independently through wavelength division multiplexing, which is not within a phase-stabilized closed-loop feedback loop and is easily affected by environmental factors such as the temperature and the vibration, thereby affecting stability and consistency of a final received broadband microwave frequency signal.

### SUMMARY

In view of defects in the prior art, the present disclosure provides a microwave photon broadband phase-stabilized transmission center station based on amplitude-phase multiplexing and transmission system having the same.

In a first aspect, the present disclosure provides the microwave photon broadband phase-stabilized transmission center station based on amplitude-phase multiplexing. The microwave photon broadband phase-stabilized transmission center station comprises a sensing reference signal source, a modulation unit, and a delay adjustment unit.

The sensing reference signal source is configured to output a sensing reference signal.

The modulation unit is configured to convert a broadband microwave signal to be transmitted to an optical domain through intensity modulation to form a central station optical carrier broadband microwave signal, and load the sensing reference signal onto the central station optical carrier broadband microwave signal through phase modulation to form a composite optical carrier broadband microwave signal.

The delay adjustment unit is configured to output the composite optical carrier broadband microwave signal sent by the modulation unit to an optical fiber link after delaying, and is configured to receive the loopback composite optical carrier broadband microwave signal from the optical fiber link, and compensate for a true delay fluctuation of the optical fiber link according to the loopback optical carrier sensing reference signal.

In a second aspect, the present disclosure provides the microwave photon broadband phase-stabilized transmission system based on amplitude-phase multiplexing. The microwave photon broadband phase-stabilized transmission system comprises a central station unit, an optical fiber link, and a remote user unit.

The central station unit is the microwave photon broadband phase-stabilized transmission center station mentioned above. The optical fiber link is configured for bidirectional transmission of an optical signal. A first end of the optical fiber link is connected to the central station unit, and a second end of the optical fiber link is connected to the remote user unit. The remote user unit is configured to receive the composite optical carrier broadband microwave signal from the optical fiber link and reflect and transmit the composite optical carrier broadband microwave signal. A reflected composite optical carrier broadband microwave signal returns to the optical fiber link to form a loopback composite optical carrier broadband microwave signal. A transmitted composite optical carrier broadband microwave signal is output after photoelectric conversion.

In the present disclosure, the broadband microwave signal to be transmitted is converted into the optical domain through the intensity modulation, and the sensing reference signal is loaded onto the central station optical carrier broadband microwave signal through the phase modulation, and the delay/phase information of the optical fiber link between the central station unit and the remote user unit is extracted through a loopback method, and the true delay fluctuation of the optical fiber link is compensated by the adjustable optical delay line, so that a total transmission delay from the central station unit to the remote user unit is a constant value, thereby achieving phase stability of the broadband microwave signal transmitted by the optical fiber link.

### BRIEF DESCRIPTION OF DRAWINGS

FIG. 1 is a block diagram of a microwave photon broadband phase-stabilized transmission center station based on amplitude-phase multiplexing according according to one embodiment of the present disclosure.

FIG. 2 is a block diagram of a microwave photon broadband phase-stabilized transmission system based on amplitude-phase multiplexing according to one embodiment of the present disclosure.

FIG. 3 is a block diagram of a remote user unit according to one embodiment of the present disclosure.

### DETAILED DESCRIPTION

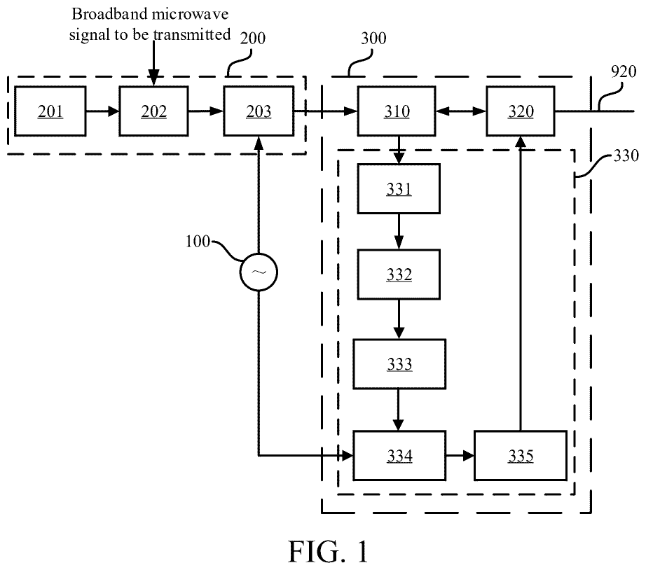

FIG. 1 is a block diagram of a microwave photon broadband phase-stabilized transmission center station based on amplitude-phase multiplexing according according to one embodiment of the present disclosure. As shown in FIG. 1, the microwave photon broadband phase-stabilized transmission center station comprises a sensing reference signal source 100, a modulation unit 200, and a delay adjustment unit 300. The sensing reference signal source 100 is configured to output a sensing reference signal. The sensing reference signal is a sinusoidal wave signal. A frequency of the sensing reference signal is generally much less than a frequency of a broadband microwave signal to be transmitted, so as to facilitate subsequent filtering of a loopback broadband microwave signal to be transmitted.

The modulation unit 200 is configured to convert the broadband microwave signal to be transmitted to an optical domain through intensity modulation to form a central station optical carrier broadband microwave signal, and is configured to load the sensing reference signal onto the central station optical carrier broadband microwave signal through phase modulation to form a composite optical carrier broadband microwave signal.

The modulation unit 200 comprises a laser 201, an intensity modulator 202 and a phase modulator 203. The laser 201 is configured to generate an optical carrier. An output end of the laser 201 is connected to an optical input end of the intensity modulator 202.

The intensity modulator 202 is configured to modulate the broadband microwave signal to be transmitted onto the optical carrier through intensity modulation, so that the broadband microwave signal to be transmitted is converted into the optical domain to form the central station optical carrier broadband microwave signal. A radio frequency end of the intensity modulator 202 is configured to receive the broadband microwave signal to be transmitted. An optical output end of the intensity modulator 202 is connected to an optical input end of the phase modulator 203.

The phase modulator 203 is configured to load the sensing reference signal onto the central station optical carrier broadband microwave signal through phase modulation, so that the sensing reference signal is converted into the optical domain to form the composite optical carrier broadband microwave signal. A radio frequency end of the phase modulator 203 is connected to the sensing reference signal source 100.

The delay adjustment unit 300 is configured to output the composite optical carrier broadband microwave signal sent by the modulation unit 200 to an optical fiber link 920 after delaying, is configured to receive the loopback composite optical carrier broadband microwave signal from the optical fiber link 920, and is configured to compensate for a true delay fluctuation of the optical fiber link 920 according to delay/phase information of the loopback optical carrier sensing reference signal. Thus, a total transmission delay from a central station unit 910 to a remote user unit 930 is a fixed value. The delay adjustment unit 300 comprises an optical routing module 310, an adjustable optical delay line 320, and a delay control module 330.

The optical routing module 310 is configured to output the composite optical carrier broadband microwave signal sent by the modulation unit 200 to the adjustable optical delay line 320 and output the loopback composite optical carrier broadband microwave signal sent by the adjustable optical delay line 320 to the delay control module 330. In the embodiment, the optical routing module 310 is an optical circulator configured to realize unidirectional input and output of the optical signal. A first end of the optical routing module 310 is connected to an optical output end of the phase modulator 203. The optical signal input to the first end of the optical circulator is output from the second end of the optical circulator, and the optical signal input to the second end of the optical circulator is output from a third end of the optical circulator.

The adjustable optical delay line 320 is configured to adjust a delay of an optical signal under a control of the delay control module 330. A first optical end of the adjustable optical delay line 320 is connected to the optical routing module 310. A second optical end of the adjustable optical delay line 320 is connected to the optical fiber link 920. A control end of the adjustable optical delay line 320 is connected to the delay control module 330.

The delay control module 330 is configured to extract the delay/phase information of the optical fiber link 920 from the central station unit to the remote user unit through the loopback optical carrier sensing reference signal, and is configured to control the adjustable optical delay line 320 to compensate for the true delay fluctuation of the optical fiber link 920. In the embodiment, the delay control module 330 comprises a phase-amplitude converter 331, a first photodetector 332, an electrical amplification and filtering module 333, a phase delay measurement module 334, and a microcontroller 335.

The phase-amplitude converter 331 is configured to receive the loopback composite optical carrier broadband microwave signal output by the optical routing module 310 and perform phase-to-amplitude mapping on the loopback composite optical carrier broadband microwave signal to obtain an amplitude-mapped composite optical carrier broadband microwave signal; An input end of the phase-amplitude converter 331 is connected to the third end of the optical circulator. An output end of the phase-amplitude converter 331 is connected to an optical end of the first photodetector 332. The phase-amplitude converter 331 is an asymmetric Mach-Zehnder interferometer or a narrow-band optical filter.

The phase-amplitude converter 331 is mainly configured to perform phase-to-amplitude mapping on the loopback optical carrier sensing reference signal in the loopback composite optical carrier broadband microwave signal (i.e., a signal formed after the sensing reference signal in the composite optical carrier broadband microwave signal is looped back). Since the sensing reference signal is converted to the optical domain by the phase modulation, and the first photodetector is only able to restore an amplitude modulated signal to a microwave domain, it is necessary to map the loopback optical carrier sensing reference signal from a phase modulation mode to an amplitude modulation mode so as to restore the loopback optical carrier sensing reference signal to the microwave domain using the first photodetector.

The first photodetector 332 is configured to perform photoelectric conversion on the amplitude-mapped composite optical carrier broadband microwave signal and restore the amplitude-mapped composite optical carrier broadband microwave signal to the microwave domain to obtain loopback electrical signal. A radio frequency end of the first photodetector 332 is connected to an input end of the electrical amplification and filtering module 333.

Since the loopback composite optical carrier broadband microwave signal further comprises a loopback optical broadband microwave signal to be transmitted (i.e., a signal formed after the loopback broadband microwave signal to be transmitted in the composite optical carrier broadband microwave signal), at this time, the loopback optical broadband microwave signal to be transmitted is also restored to the microwave domain to obtain a loopback broadband microwave signal to be transmitted. That is, the loopback electrical signal output by the first photodetector 332 is a composite electrical signal including the loopback sensing reference signal and the loopback broadband microwave signal to be transmitted.

The electrical amplification and filtering module 333 is configured to electrically amplify and electrically filter the loopback electrical signal output by the first photodetector 332, thereby filtering out the loopback broadband microwave signal to be transmitted and outputting the loopback sensing reference signal. An output end of the electrical amplification and filtering module 333 is connected to an first input end of the phase delay measurement module 334.

The phase delay measurement module 334 is configured to extract the phase/delay information of the optical fiber link 920 according to the sensing reference signal sent by the sensing reference signal source 100 and the loopback sensing reference signal sent by the electrical amplification and filtering module 333. A second input end of the phase delay measurement module 334 is connected to the sensing reference signal source 100, and an output end of the phase delay measurement module 334 is connected to an input end of the microcontroller 335.

The phase delay measurement module 334 comprises a phase detector configured to detect phases at a single point to realize broadband stable phase transmission. Since there is a problem of period ambiguity when using a single sine wave for phase measurement, the sensing reference signal source may be a frequency-adjustable signal source configured to output the sensing reference signal with an adjustable frequency, so that a plurality of sine waves of different frequencies are configured as the sensing reference signal to overcome the problem of period ambiguity of the single sine wave. The phase delay measurement module 334 uses the phase detector to detect phases at multiple points to ensure broadband multi-path phase consistency and repeatability transmission.

The microcontroller 335 is configured to adjust a delay of the adjustable optical delay line 320 according to the phase/delay information of the optical fiber link 920 extracted by the phase delay measurement module 334, so that a sum of an additional delay of the adjustable optical delay line 320 and a transmission delay of the optical fiber link 920 is maintained as a predetermined constant c. An output end of the microcontroller 335 is connected to the control end of the adjustable optical delay line 320.

In the embodiment, the sensing reference signal and the broadband microwave signal are transmitted in one optical fiber through amplitude and phase multiplexing, which avoids an influence of environmental factors such as temperature and vibration outside a closed feedback loop of the sensing reference signal and the broadband microwave signal being independently subjected to wavelength division multiplexing modulation and demodulation, thereby achieving ultra-high precision broadband stable phase transmission.

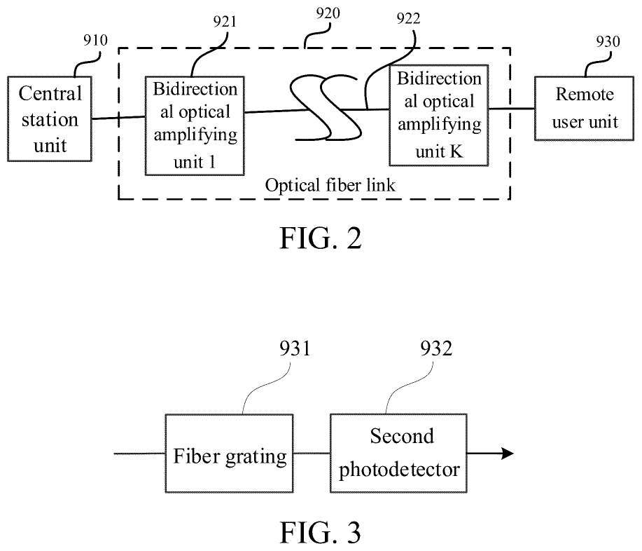

FIG. 2 is a block diagram of a microwave photon broadband phase-stabilized transmission system based on amplitude-phase multiplexing according to one embodiment of the present disclosure. As shown in FIG. 2, the microwave photon broadband phase-stabilized transmission system comprises a central station unit 910, an optical fiber link 920, and a remote user unit 930.

The central station unit 910 is the microwave photon broadband phase-stabilized transmission center station mentioned above.

The optical fiber link 920 is configured for bidirectional transmission of the optical signal. A first end of the optical fiber link 920 is connected to the central station unit 910, and a second end of the optical fiber link 920 is connected to the remote user unit 930.

In the embodiment, the optical fiber link 920 is a single-fiber bidirectional serial optical link, the optical fiber link 920 is formed by connecting bidirectional optical amplifying units 921 in series by optical amplifying units 922. The bidirectional optical amplifying units 921 are configured to perform power compensation on the optical signal bidirectionally transmitted on the optical fiber link 920.

As shown in FIG. 3, the remote user unit 930 is configured to receive the composite optical carrier broadband microwave signal from the optical fiber link 920 and reflect and transmit the composite optical carrier broadband microwave signal. A reflected composite optical carrier broadband microwave signal returns to the optical fiber link 920 to form the loopback composite optical carrier broadband microwave signal. A transmitted composite optical carrier broadband microwave signal is output after photoelectric conversion.

In the embodiment, the remote user unit 930 comprises a fiber grating 931 and a second photodetector 932. The fiber grating 931 is configured to receive the composite optical carrier broadband microwave signal from the optical fiber link 920 and reflect and transmit the composite optical carrier broadband microwave signal. The reflected composite optical carrier broadband microwave signal returns to the optical fiber link 920, and the transmitted composite optical carrier broadband microwave signal is output to the second photodetector 932.

The second photodetector 932 is configured to perform photoelectric conversion on the transmitted composite optical carrier broadband microwave signal to restore the broadband microwave signal to be transmitted. Since the sensing reference signal is converted to the optical domain by the phase modulation, and the second photodetector is only able to restore the amplitude modulated signal to the microwave domain, the second photodetector only restores the broadband microwave signal to be transmitted from the composite optical carrier broadband microwave signal, but does not restore the sensing reference signal.

A working principle of the present disclosure is as follows.

As shown in FIGS. 1-3, in a working state, the laser 201 outputs an optical carrier with a frequency of ω₀, and an optical field thereof is expressed as:

$${E}_{0} ( t ) = {E}_{0} exp ( j {ω}_{0} t ) \qquad ( 1 )$$

E₀A represents an amplitude of the optical field.

Then, the broadband microwave signal to be transmitted is loaded onto the optical carrier through the intensity modulator 202 to form the central station optical carrier broadband microwave signal. An optical field E_{AM}(t) of the central station optical carrier broadband microwave signal is expressed as:

$${E}_{AM} ( t ) = {E}_{0} ( t ) cos [ {χ}_{1} cos ( {ω}_{t} t + {θ}_{t} ) ] exp ( j {ω}_{0} t ) \qquad ( 2 )$$

χ₁ is a modulation coefficient of the intensity modulator 202, which is related to a ratio of a supply voltage on the intensity modulator to a half-wave voltage of the intensity modulator itself. ωₜ is an angular frequency of the broadband microwave signal to be transmitted. θₜ is a phase of the the broadband microwave signal to be transmitted. Expanding equation (2) according to the Bessel series, and a formula obtained is as follows:

$${E}_{AM} ( t ) = \frac{\sqrt{2}}{2} {E}_{0} ( t ) \{ {J}_{0} ( {χ}_{1} ) + {\sum }_{a = 1}^{∞} {J}_{2 a} ( {χ}_{1} ) [ exp ( j 2 a ( {ω}_{t} t + {θ}_{t} ) ) + exp ( - j 2 a ( {ω}_{t} t + {θ}_{t} ) ) ] + {\sum }_{a = 1}^{∞} {( - 1 )}^{a} {J}_{2 a - 1} ( {χ}_{1} ) [ exp ( j ( 2 a - 1 ) ( {ω}_{t} t + {θ}_{t} ) ) + exp ( - 1 ( 2 a - 1 ) ( {ω}_{t} t + {θ}_{t} ) ) ] \} \qquad ( 3 )$$

J( ) represents a Bessel function of a first kind. The subscript represents the order of the Bessel function. The integer a is a summation parameter.

Then, the sensing reference signal source 100 outputs the sensing reference signal with an angular frequency of ω_{ref} and a phase of θ_{ref}, and the sensing reference signal is loaded onto the central station optical carrier broadband microwave signal via the phase modulator 203 to form the composite optical carrier broadband microwave signal. The optical field of the composite optical carrier broadband microwave signal is expressed as:

$${E}_{PM} ( t ) = {E}_{AM} ( t ) exp \{ j {χ}_{2} cos ( {ω}_{ref} t + {θ}_{ref} ) \} \qquad ( 4 )$$

χ₂ is a modulation coefficient of the phase modulator 203, which is related to a ratio of the supply voltage on the phase modulator to a half-wave voltage of the phase modulator itself. Expanding equation (4) according to the Bessel series, a formula obtained is as follows:

$${E}_{PM} ( t ) = {E}_{AM} ( t ) {\sum }_{b = - ∞}^{∞} {j}^{b} {J}_{b} ( {χ}_{2} ) exp \{ j b ( {ω}_{ref} t + {θ}_{ref} ) \} \qquad ( 5 )$$

Integer b is a summation parameter thereof.

Then, the composite optical carrier broadband microwave signal is coupled into the optical fiber link 920 through the optical circulator and the adjustable optical delay line 320 and is transmitted to the remote user unit. In the optical fiber link 920, the bidirectionally transmitted optical signal passes through the bidirectional optical amplifying units 921 for optical power compensation.

After the remote user unit receives the composite optical carrier broadband microwave signal from the optical fiber link 920, the remote user unit loops a part of the composite optical carrier broadband microwave signal back to the optical fiber link 920 through a reflection function of the fiber grating to form the loopback composite optical carrier broadband microwave signal, and outputs a part of the composite optical carrier broadband microwave signal to the second photodetector through a transmission function of the fiber grating. The second photodetector restores the broadband microwave signal to be transmitted from the received composite optical carrier broadband microwave signal, which is expressed as:

$${V}_{1} ( t ) ∝ cos [ {ω}_{t} ( t - {τ}_{f} - {τ}_{VODL} ) + {θ}_{t} ] \qquad ( 6 )$$

τ_{f} represents the transmission delay of the optical fiber link, and τ_{VODL} represents the additional delay of the adjustable optical delay line 320.

After the loopback composite optical carrier broadband microwave signal is looped back to the central station unit through the optical fiber link 920, it enters the phase-amplitude converter 331 through the adjustable optical delay line 320 and the optical circulator, and after the phase-amplitude converter 331 performs phase-to-amplitude mapping, the loopback composite optical carrier broadband microwave signal is restored to the microwave domain through the first photodetector 332 to obtain the loopback electrical signal. After the loopback electrical signal is electrically amplified and electrically filtered by the electrical amplification and filtering module 333, the loopback broadband microwave signal to be transmitted is filtered out, and the loopback sensing reference signal is output. The loopback sensing reference signal is expressed as:

$${V}_{2} ( t ) ∝ cos [ {ω}_{ref} ( t - {τ}_{f} - {τ}_{VODL} ) + {θ}_{ref} ] \qquad ( 7 )$$

The phase delay measurement module 334 extracts the phase/delay information or change information of the optical fiber link 920 according to the sensing reference signal and the loopback sensing reference signal, and drives the adjustable optical delay line 320 to adjust the delay accordingly, so that the sum of the additional delay of the adjustable optical delay line 320 and the transmission delay of the optical fiber link 920 is maintained as the predetermined constant c. A formula obtained is as follows:

$${τ}_{f} + {τ}_{VODL} = c \qquad ( 8 )$$

c is the predetermined constant. At this time, the formula (6) is expressed as

$${V}_{1} ( t ) ∝ cos [ {ω}_{t} ( t - c ) + {θ}_{t} ] \qquad ( 9 )$$

Since c is the predetermined constant, the phase of the broadband microwave signal received by the remote user unit is kept stable. In particular, when multi-channel stable phase transmission is performed, if c of each channel is the same constant, multi-channel phase consistent transmission is achieved.

In the present disclosure, the broadband microwave signal to be transmitted is converted into the optical domain through the intensity modulation, and the sensing reference signal is loaded onto the central station optical carrier broadband microwave signal through the phase modulation, and the delay/phase information of the optical fiber link 920 between the central station unit 910 and the remote user unit 930 is extracted through a loopback method, and the true delay fluctuation of the optical fiber link 920 is compensated by the adjustable optical delay line 320, so that a total transmission delay from the central station unit 910 to the remote user unit 930 is a constant value, thereby achieving phase stability of the broadband microwave signal transmitted by the optical fiber link 920.

What is claimed is:

1. A microwave photon broadband phase-stabilized transmission center station based on amplitude-phase multiplexing, comprising:
a sensing reference signal source, configured to output a sensing reference signal;
a modulation unit, configured to convert a broadband microwave signal to be transmitted to an optical domain through intensity modulation to form a central station optical carrier broadband microwave signal, and load the sensing reference signal onto the central station optical carrier broadband microwave signal through phase modulation to form a composite optical carrier broadband microwave signal; and
a delay adjustment unit, configured to output the composite optical carrier broadband microwave signal sent by the modulation unit to an optical fiber link after delaying, receive the loopback composite optical carrier broadband microwave signal from the optical fiber link, and compensate for a true delay fluctuation of the optical fiber link according to the loopback optical carrier sensing reference signal.

2. The microwave photon broadband phase-stabilized transmission center station according to claim 1, wherein a frequency of the sensing reference signal is less than a frequency of the broadband microwave signal to be transmitted.

3. The microwave photon broadband phase-stabilized transmission center station according to claim 1, wherein the modulation unit comprises a laser, an intensity modulator and a phase modulator; the laser is configured to generate an optical carrier; the intensity modulator is configured to modulate the broadband microwave signal to be transmitted onto the optical carrier through the intensity modulation to form the central station optical carrier broadband microwave signal; and the phase modulator is configured to load the sensing reference signal onto the central station optical carrier broadband microwave signal through phase modulation to form the composite optical carrier broadband microwave signal.

4. The microwave photon broadband phase-stabilized transmission center station according to claim 1, wherein the delay adjustment unit comprises an optical routing module, an adjustable optical delay line, and a delay control module;
wherein the optical routing module is configured to output the composite optical carrier broadband microwave signal sent by the modulation unit to the adjustable optical delay line and output the loopback composite optical carrier broadband microwave signal sent by the adjustable optical delay line to the delay control module;
wherein the adjustable optical delay line is configured to adjust a delay of an optical signal under a control of the delay control module, a first optical end of the adjustable optical delay line is connected to the optical routing module, a second optical end of the adjustable optical delay line is connected to the optical fiber link, and a control end of the adjustable optical delay line is connected to the delay control module;
wherein the delay control module is configured to extract delay/phase information of the optical fiber link from a central station unit to a remote user unit through the loopback optical carrier sensing reference signal, and control the adjustable optical delay line to compensate the true delay fluctuation of the optical fiber link.

5. The microwave photon broadband phase-stabilized transmission center station according to claim 4, wherein the delay control module comprises a phase-amplitude converter, a first photodetector, an electrical amplification and filtering module, a phase delay measurement module, and a microcontroller;
wherein the phase-amplitude converter is configured to receive the loopback composite optical carrier broadband microwave signal output by the optical routing module and perform phase-to-amplitude mapping on the loopback composite optical carrier broadband microwave signal to obtain an amplitude-mapped composite optical carrier broadband microwave signal;
wherein the first photodetector is configured to perform photoelectric conversion on the amplitude-mapped composite optical carrier broadband microwave signal and restore the amplitude-mapped composite optical carrier broadband microwave signal to a microwave domain to obtain a loopback electrical signal;
wherein the electrical amplification and filtering module is configured to electrically amplify and electrically filter the loopback electrical signal output by the first photodetector and output a loopback sensing reference signal;
wherein the phase delay measurement module is configured to extract the phase/delay information of the optical fiber link according to an adjustable sensing reference signal and a loopback adjustable sensing reference signal;
wherein the microcontroller is configured to adjust a delay of the adjustable optical delay line according to the phase/delay information of the optical fiber link, so that a sum of an additional delay of the adjustable optical delay line and a transmission delay of the optical fiber link is maintained as a predetermined constant.

6. The microwave photon broadband phase-stabilized transmission center station according to claim 5, wherein the phase-amplitude converter is an asymmetric Mach-Zehnder interferometer or a narrow-band optical filter.

7. The microwave photon broadband phase-stabilized transmission center station according to claim 5, wherein the phase delay measurement module comprises a phase detector configured to detect phases at a single point to realize broadband stable phase transmission; or
the sensing reference signal source is a signal source with adjustable output frequency, the sensing reference signal source is configured to output the sensing reference signal with an adjustable frequency, and the phase delay measurement module comprises the phase detector configured to detect phases at multiple points to ensure broadband multi-path phase consistency and repeatability transmission.

8. A microwave photon broadband phase-stabilized transmission system based on amplitude-phase multiplexing, comprising:
a central station unit, wherein the central station unit is the microwave photon broadband phase-stabilized transmission center station according to claim 1,
the optical fiber link for bidirectional transmission of an optical signal; and
a remote user unit;
wherein a first end of the optical fiber link is connected to the central station unit, and a second end of the optical fiber link is connected to the remote user unit; the remote user unit is configured to receive the composite optical carrier broadband microwave signal from the optical fiber link and reflect and transmit the composite optical carrier broadband microwave signal; a reflected composite optical carrier broadband microwave signal returns to the optical fiber link to form a loopback composite optical carrier broadband microwave signal, and a transmitted composite optical carrier broadband microwave signal is output after photoelectric conversion.

9. The microwave photon broadband phase-stabilized transmission system according to claim 8, wherein the optical fiber link is a single-fiber bidirectional serial optical link, the optical fiber link is formed by connecting bidirectional optical amplifying units in series by optical fibers; the bidirectional optical amplifying units are configured to perform power compensation on the optical signal bidirectionally transmitted on the optical fiber link.

10. The microwave photon broadband phase-stabilized transmission system according to claim 8, wherein the remote user unit comprises a fiber grating and a second photodetector,
wherein the fiber grating is configured to receive the composite optical carrier broadband microwave signal from the optical fiber link and reflect and transmit the composite optical carrier broadband microwave signal; a reflected composite optical carrier broadband microwave signal returns to the optical fiber link, and a transmitted composite optical carrier broadband microwave signal is output to the second photodetector;
wherein the second photodetector is configured to perform photoelectric conversion on the transmitted composite optical carrier broadband microwave signal to restore the broadband microwave signal to be transmitted.
